(19) United States
(12) Patent Application Publication
(10) Pub. No.: US 2005/0243418 A1
(43) Pub. Date: Nov. 3, 2005

(54) Adjustable display stereoscope

(76) Inventor: William H.T. La, Saratoga, CA (US)

Correspondence Address: William La, 5339 Prospect Rd. # 333, San Jose, CA, 95129, US

(21) Appl. No.: 10/836,701

(22) Filed: Apr. 29, 2004

(51) Int. Cl. G03B 35/00

(52) U.S. Cl. 359/477; 359/474

(57) ABSTRACT

A stereoscopic display system (10) comprising a pair of convergent lenses (14) and a sheet of resilient, transparent material (12) formed into a picture holder (18) and a lens holder (20) joined by a base (16) that holds them erect and parallel for viewing a stereoscopic image pair mounted in the picture holder through the lenses mounted in the lens holder. A median slot (21) extending through the lens holder into an adjacent portion of the base divides these sections into two lens support arms (31) and provides an intervening space shaped to accommodate the viewer's nose and to maintain a clearance space for the resilient approximation of the lens support arms. Adjustments for focus, diopter, interpupillary distance, and stereofield separation and vertical alignment, are made by flexing the lens support arms collectively and differentially in longitudinal and transverse directions. The picture holder is adapted to durably or transiently hold stereograms of various sizes and formats, in the form of prints, transparencies or slides, LCDs or other thin image support media. A second picture can be displayed on the reverse side of the picture holder. The lens holder can accept replacement optics for optics for customization to the user's vision requirements and can be adapted for durable setting of interocular distance.

### CROSS REFERENCE TO RELATED APPLICATIONS

Not Applicable

### FEDERALLY SPONSORED RESEARCH

Not Applicable

### SEQUENCE LISTING OR PROGRAM

### Not Applicable

### BACKGROUND OF THE INVENTION

1. Field of Invention

This invention relates to stereoscopes, and more specifically to stereoscopes that include a twin-lens eyepiece connected to a holder for a stereogram. This invention applies to stereograms that are composed of two adjacent images, or fields, each corresponding to one eye. A stereogram is understood as a stereoscopic image generated by any method, and a stereograph more specifically as a photographic stereogram, these two words being used interchangeably herein.

2. Description of Prior Art

Our perception of depth in our surroundings comes from many visual cues, an important one being the parallax of the two similar but non-identical images seen by our two eyes. A stereograph presents two views of a scene that incorporate a shift in viewpoint parallel to the line joining the centers of the two images, not necessarily in a horizontal plane and not necessarily by the same distance as separates human eyes, such that when each view is exclusively presented to its corresponding eye, the two fields are fused into a realistic three-dimensional perception of the scene. If a stereograph is configured so that when held up for viewing, the left image squarely faces the left eye while the right image squarely faces the right eye, the 3-D picture can be free-viewed by a trained user maintaining a parallel gaze while accommodating his sight to the plane of the images. The illusion of depth afforded by a properly formatted stereogram can thus be appreciated with nothing more than a pair of naked eyes with adequate vision.

There are, however, serious limitations associated with this method of enjoying a stereo picture. First, many people find it difficult or impossible to maintain parallel lines of sight while focusing on a near object. Second, a stereo pair viewed in this manner appears as three distinct images, the three-dimensional one in the center being flanked on both sides by distracting flat counterparts. Third, since our eyes cannot be made to diverge to any significant extent, a stereo pair configured for such use is necessarily limited to a maximum field separation substantially equal to the interpupillary distance, approximately 6.5 cm (2.5 in). This also limits the width of the 3-D image to 6.5 cm which, at a comfortable minimum viewing distance of 25 cm (10 in), represents a horizontal angular field of view of only 15 degrees. Though practicable, free-viewing is therefore unsatisfying and fails to exploit the full potential of third dimensional representation possible with a pair of 2-D images.

According to historical references, stereoscopy predates photography: Wheatstone invented the stereoscope in 1838 using an arrangement of mirrors to view stereograms, just one year before photography was developed by Daguerre. The stereoscope without mirrors was proposed by Brewster, and Holmes improved on the concept by using lenses off-center to act as prisms. Many improvements have been made over the years to advance the art of 3-D representation from twin 2-D pictures.

A straightforward solution to the limitations cited above is accomplished with the lorgnette type of stereo viewer, as exemplified by U.S. Pat. No. 2,849,917 to Petri, 1953 May 29. A pair of convergent lenses is held in front of the eyes and the stereograph is placed a focal distance away. This brings the physical image closer while pushing its virtual counterpart out to infinity, thereby facilitating visual accommodation while also increasing the angular field of view. The nasal side of each lens is frosted to act as an optical septum, blocking out of each eyeview the distracting contralateral field. In addition, the lenses are configured in a base-out prism geometry, allowing the lines of sight to diverge, thereby enabling the use of larger images, and further amplifying the field of view. While simple and inexpensive, this handheld device suffers from a lack of steady support of the stereograph for alignment with the eyepiece, rendering its operation difficult for many users.

U.S. Pat. No. 4,730,898 to Curtin, 1988 Mar. 15, shows a viewer of the same type, but of a more complex construction, including appendages allowing it to be worn like a pair of eyeglasses. This apparatus uses lens fragments of a smaller size to limit the field of view and eliminate the need for a septum, but still does not adequately address the problem of securely squaring the viewer and the view. U.S. Pat. No. 4,172,633 to Hashimoto et al., 1979 Oct. 30, shows a viewer that can be thought of as a lorgnette-type stereoscope fitted with panels, including a septum, designed to keep it at a predetermined distance from a stereographic target, with the eyepiece held in a parallel configuration. This device is advantageous for viewing either 3-D images displayed in a book or stereoscopic pictures lying flat on a surface, with a simple provision for adjusting interocular distance, but is not adapted for holding a card in position.

The secure, square holding problem is addressed explicitly by the class of stereoscopes that include both a 3-D eyepiece and a mounting system for the stereograph, some early examples of which include the view box shown in U.S. Pat. No. 61,359 to Rawson, 1867 Jan. 22, the stereoscopic book of U.S. Pat. No. 174,893 to Bierstadt, 1876 Mar. 21, and the parlor-style stereoscope of U.S. Pat. No. 262,846 to Stevens, 1882 Aug. 15. Stereoscope design shows a height of sophistication and complexity with the slide viewing apparatus of U.S. Pat. No. 2,484,591 to Rochwite, 1945 May 8, which incorporates a light source and provides mechanisms for adjustment of focus and interocular distance, in a closed, injection-molded body. On the other hand, the relatively simple, binoculars-like slide viewer of U.S. Pat. No. 2,511,334 to Gruber, 1947 Apr. 28, includes a mechanism for manually cycling through seven pairs of slides mounted on a disc, with the title of the current view showing through a window. This design, marketed as the ViewMaster®, has encountered great commercial success and is currently the only stereoscope that is widely available to the general public. However, this device is presented and regarded as a child's toy, and there is no accessible way for a user to make her own stereo slides to view with it. Moreover, the available images cannot be enjoyed independently of the viewer. A recent update of the ViewMaster®, shown in U.S. Pat. No. 6,031,662 to Miller et al., 2000 Feb. 29, suffers from the same limitations but can serve as binoculars.

Other designs can be found in the prior art. Some improvements emphasize the incorporation of a large amount of content in the fashion of a book, such as U.S. Pat. No. 2,616,333 to Tinker, 1952 Nov. 4; U.S. Pat. No. 5,204,776 to Seamans and Harvey, 1993 Apr. 20; and U.S. Pat. No. 6,456,433 to Jones, 2002 Sep. 24. These specialized devices have relatively complex designs and require multiple steps in their manufacture. The Jones patent shows provisions for synchronized adjustment of interocular distance.

Others improvements stress portability in a collapsible arrangement, such as U.S. Pat. No. 2,724,991 to Levine, 1955 Nov. 29; U.S. Pat. No. 5,002,363 to Tanaka, 1991 Mar. 26; U.S. Pat. No. 5,136,423 to Curtin, 1992 Aug. 4; and U.S. Pat. No. 5,940,210 to Kassawat, 1999 Aug. 17. These viewers range from the simplest, such as Tanaka's, to the most complicated, such as Kassawat's, but all are compact, efficient and inexpensive. However, they lack adjustment capability and their general appearance matches their low cost. Kassawat's and some of Curtin's embodiments follow the ViewMaster® design philosophy, relying on an assemblage of walls, windows and septa to corral the user's sight from each eye onto the desired area of space. While this technique incrementally facilitates stereo viewing, it interferes with the visibility of the picture with respect to a bystanding observer, and detracts from the display value of the stereoscope.

The prismatic Holmes stereoscope continues to be improved upon and updated, as exemplified by U.S. Pat. No. 4,789,220 to Kinnard, 1987 Apr. 24; and U.S. Pat. No. 5,058,990 to Bush, 1991 Oct. 22. The Kinnard invention is foldable and adjustable in many dimensions, but, like the ViewMaster®, uses a proprietary format for the stereogram. Its complex mechanical versatility encompasses reconfiguration as a dual-power magnifier. The Bush invention is assembled from substantially flat, easily fabricated interlocking pieces, and can be readily separated into its components for compact transport. However, adjustability is absent and the instrument has to be partially disassembled in order to change the view. A limitation common to septated stereoscopes is the difficulty in evenly lighting the stereograph.

Stereophotography was widely practiced and appreciated in the late nineteenth and the early twentieth centuries, and along with stereographs, stereoscopes enjoyed wide distribution and use. Nowadays, the field of stereoscopy is dormant and the art is practiced mostly by a small niche of aficionados catered to by a handful of specialized websites. Aside from the ViewMaster®, no other stereoscope is readily available to the public. As consumer interest surges for digital cameras, and the means for generating and printing high-resolution color images become more available and affordable at the personal computing level, photography in general is thriving while stereography is withering. There exists no accessible way for the average person to engage in creating, viewing and exhibiting quality stereographs of friends and family. Even though the science is well-known, the art has not kept up with advancing technology and evolving tastes. The stereoscope is now perceived as either a child's toy or a relic from the past, its vast potential for amusing, teaching and inspiring ignored. The adjustable stereoscopic display system of this invention is intended to help advance the art.

### OBJECTS AND ADVANTAGES

Accordingly, several objects and advantages of the present invention are to provide:

(a) a self-standing display system for stereoscopic visual content that securely holds, supports, protects, and exhibits the content material, and is adapted for stable upright setting on a horizontal surface, or optional mounting on a vertical or slanted surface;

(b) an aesthetically pleasing stereoscopic display that has a clean, uncluttered, stylish and modern appearance, is suitable for use as a decorative object, and has wide appeal for people of various ages and interests in a home or place of business;

(c) an easy to use stereoscopic apparatus that has a simple design with an intuitive operation of the various adjustment mechanisms, and requires a minimum amount of effort, skill or care on the part of the user;

(d) a practical stereoscope that fits a large proportion of the people who have adequate binocular eyesight, providing adjustable interocular distance, focus, and diopter compensation, as well as compensation for vertical misalignment of stereofields;

(e) a customizable 3D optical viewer with easily removed and interchangeable lenses, allowing for individualization to a user's vision requirements;

(f) a versatile stereoscopic display system that is optimized to accept various formats of stereograms, in print, transparency, slide, LCD or other thin media form, either permanently mounted or configured as loose stereo pairs or montages;

(g) an accessible stereoscopy method whereby an average person can make, view and show her own stereographic creations without requiring specialized stereo cameras or image processing equipment;

(h) an adaptable display system capable of securely holding two pictures facing opposite directions, as well as receiving a temporary stereo image for transient viewing;

(i) an economical and environmentally friendly stereoscopic display that maximally uses ambient light and requires no special source of light or energy to operate;

(j) a lightweight yet robust three-dimensional viewing apparatus that is readily handled by adults and children alike, being economical of material while not easily rendered inoperable;

(k) an easy to manufacture 3-D optical device of simple construction with a minimum number of parts;

(l) a simple and inexpensive stereoscopic display system suitable for adoption by a wide segment of the general public, marketable as a natural extension of existing photographic product lines in retail stores, and applicable for entertainment as well as education.

Further objects and advantages of the present invention will become apparent from a consideration of the ensuing description and drawings.

### BRIEF SUMMARY OF THE INVENTION

In accordance with the present invention, an exemplary preferred embodiment stereoscopic display system is made from three parts: an elongated rectangular sheet of thin, transparent plastic and two convergent lenses. The transparent sheet, which constitutes the body of the stereoscope, is formed through four parallel folds into three rectangular sections: a single-layer base in the middle, a double-layer picture holder on one end, and a double-layer lens holder on the other end. The end sections are each connected to the base through a 90 degree fold and are of equal size, perpendicular to the base, and parallel to and directly facing each other, separated by a distance equal to the focal length of the lenses.

The picture holder section has two layers, or walls, of the transparent material, connected through a 180 degree fold, and accepts two pictures inserted between these walls: a stereograph facing the lenses through the internal wall, and another image facing the other direction through the external wall, both of which being removable by slight separation of the two walls. A single stereo transparency or slide can also be installed in the picture holder, to be viewed against an external light source. A cylindrical fold at the free edge of the picture holder provides a channel to temporarily retain a picture for transient viewing. A stereogram mounted in this channel is not limited by the size and format of the picture holder. Alternately, a pair of sidewings on the internal wall serves the same purpose, albeit with width limitation.

The lens holder section also has two walls connected through a 180-degree fold, and accepts the two lenses. Each lens has a peripheral flange that is held between the walls, and an optically active body that is received in matching cutouts in those walls. The lenses are symmetrically disposed about the longitudinal axis of the body, spaced 6.35 cm (2.5 in) apart, and can be inserted and removed by slightly separating the two walls. The user can opt to install corrective lenses provided as an accessory. A removable septum facilitates stereo viewing by untrained eyes.

A median slot runs from the distal edge of the lens holder section down through this entire section and onto the adjacent part of the base, up to the center of the base. The lens holder and half of the base are thus divided into two symmetrical lens support arms. The median slot is so shaped as to accommodate the user's nose when the lenses are placed against the eyes, and also to provide clearance for the resilient approximation of the lens support arms. Adjustments for variations in focus, diopter, and interpupillary or stereofield separation, as well as vertical field alignment, are done by flexing the lens support arms together or separately in longitudinal and transverse directions.

Alternately, elongated lens apertures in the walls allow the lenses to slide closer together or farther apart for durable setting of the lens separation, i.e. interocular distance, to match the user's interpupillary distance and the stereogram's field separation. Lateral flexing of the lens support arms is then needed only as a fine-tuning process. Optionally, each lens is provided with a pivot pin and an adjustment tab that protrude respectively from the bottom and top parts of the flange and are received in matching wall cutouts, allowing the user to set the lens separation without touching the lenses.

In an alternate embodiment, in which durable setting of interocular distance is provided for as above, the complete slotting of the lens holder section into two separate arms is omitted. The nose slot then has to extend only as far as needed to accommodate the nose, leaving the nasal bridge intact and encroaching less deeply into the base, resulting in a sturdier structure but allowing instant resilient adjustment for focus only.

### BRIEF DESCRIPTION OF THE DRAWINGS

Drawing Figures

In the drawings, closely related figures have the same number but different alphabetic suffixes.

FIG. 1 is a perspective view of the preferred embodiment stereoscope, including a body and two lenses.

FIG. 2A is a perspective view of the transparent plastic body without the lenses.

FIG. 2B is a plan view of the sheet material from which the body is fabricated.

FIG. 3A is a side perspective view of a lens.

FIG. 3B is a sectional detail view of a lens within its holder.

FIGS. 4A through 4C are profile views illustrating adjustment of focus and diopter.

FIGS. 5A through 5C are front views of the support arms illustrating interocular adjustment.

FIGS. 6A through 6D are profile views showing alternate flap configurations.

FIG. 7A is a perspective view of the picture holder section fitted with sidewings.

FIG. 7B is a similar perspective view of the picture holder section fitted with a channel.

FIG. 8A is a front view of the internal wall of the lens holder of the alternate embodiment seen from the picture holder.

FIG. 8B is a plan view of the base and lens holder sections of the sheet material in the alternate embodiment.

FIG. 8C is a perspective view of the lens in the alternate embodiment.

FIG. 9 is a perspective view of the removable septum

### REFERENCE NUMERALS IN DRAWINGS

In the reference numerals, suffixes A and B on a numeral respectively designate homologous left and right parts, which may also be referred to collectively by the same numeral without suffixes.
10 Stereoscope
11 Body sheet
12 Body
14 Lens
16 Base
18 Picture holder section
20 Lens holder section
21 Median slot
22 Picture holder flap edge
24 Picture holder flap
26 Picture holder flap fold
28 Picture holder panel
30 Picture holder panel fold
31 Lens support arm
32 Lens holder panel fold
34 Lens holder panel
36 Lens holder flap fold
38 Lens holder flap
40 Lens holder flap edge
42 Base nose cutout
44 Lens holder panel nose cutout
46 Lens holder panel clearance cutout
48 Lens holder flap clearance cutout
50 Lens holder flap nose cutout
52 Lens holder panel lens cutout
54 Lens holder flap lens cutout
56 Lens body
58 Lens flange
60 Retaining sidewing
61 Retaining channel
62 Lens pivot pin
64 Lens adjustment tab
66 Pivot hole
68 Adjustment tab guide
70 Septum bracket
72 Septum

### DETAILED DESCRIPTION

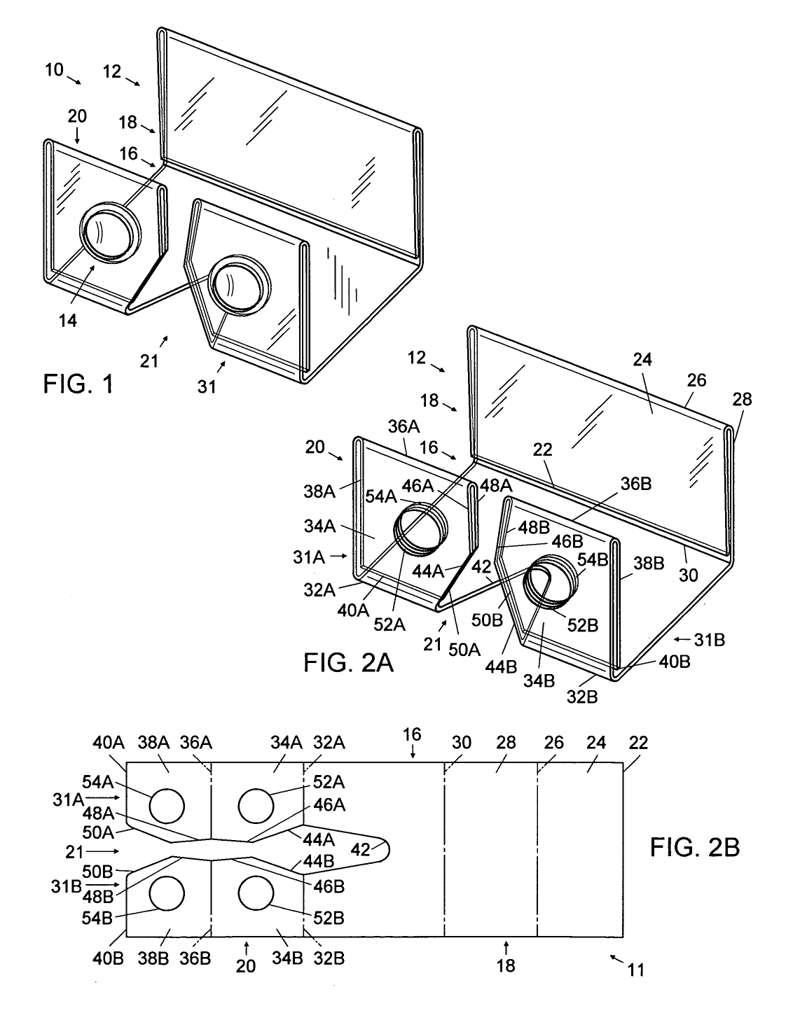

FIG. 1 shows the preferred embodiment of the adjustable display stereoscope 10 that comprises a body 12 and a pair of lenses 14. Body 12 is fabricated from a single sheet of thin transparent acrylic plastic of approximately 1.6 mm in thickness, cut in the appropriate places and heat-formed into a base section 16, a picture holder section 18 and a lens holder section 20. Median slot 21 divides the lens holder section and part of the base section into two lens support arms 31.

FIG. 2A shows body 12 without the lenses, and FIG. 2B shows cut plastic sheet 11 from which the body is fabricated by forming four folds. At the center of body 12 is base 16 which is attached on one end to picture holder 18 through fold 30. Picture holder 18 is comprised of picture holder panel 28 and picture holder flap 24, which are connected through fold 26 and end in edge 22. At the other end of base 16, nose slot 42 divides the base into two lateral members which lead through folds 32A and 32B to the left and right parts of lens holders 20, which are respectively comprised of lens holder panels 34A and 34B and lens holder flaps 38A and 38B. The latter are attached to their respective panels through folds 36A and 36B and end in edges 40A and 40B. Nose slot edges 44A and 44B as well as clearance space edges 46A and 46B are cut in panels 34A and 34B, and nose slots edges 50A and 50B as well as clearances space edges 48A and 48B are cut in flaps 38A and 38B. These slots and clearances together form continuous median slot 21 that bisects the lens holder section and part of the base section into two lens support arms 31A and 31B. In addition, lens apertures 52A and 52B are cut in panels 34A and 34B, while lens apertures 54A and 54B are cut in flaps 38A and 38B. Folds 30 and 32 may each consist of two or more component folds curved in opposite directions, not shown, to act as a spring and confer more resilience and resistance to material fatigue.

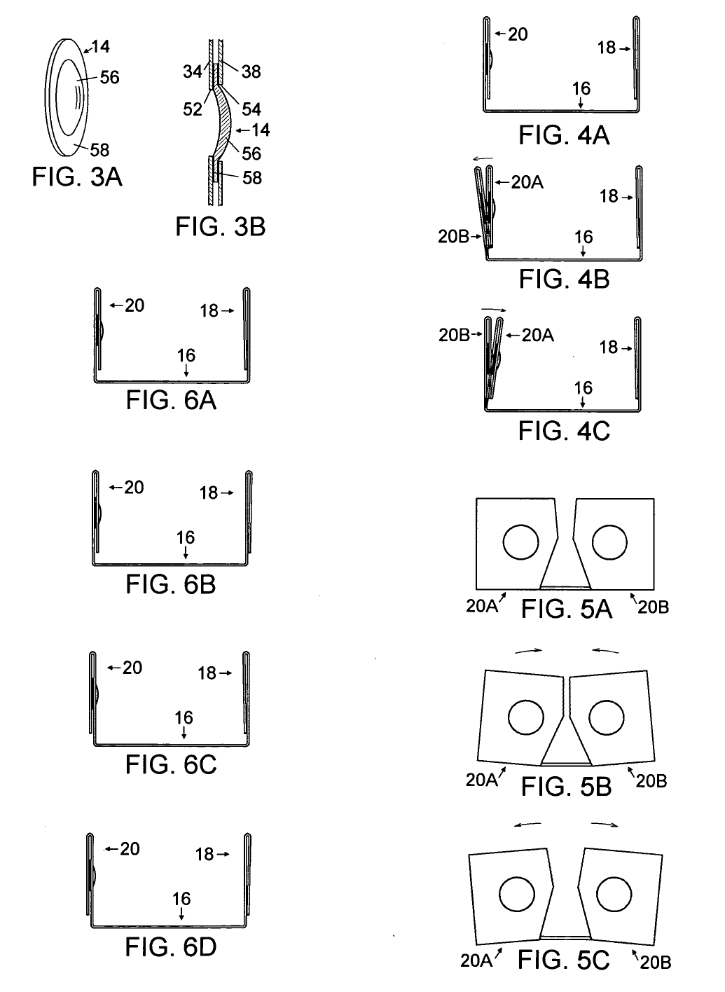

FIG. 3A shows convergent meniscus lens 14 that comprises lens body 56 and flange 58. FIG. 3B shows a cross-section of the lens mounted between panel 34 and flap 38. Lens 14 is held in place only by the tension between the two layers of material as applied by fold 36.

FIG. 4A shows the stereoscope in its resting configuration, as seen from the right, to illustrate the advantageous use of the flexibility of the sheet material to effect an adjustment. FIG. 4B shows right lens holder 20B being bent away from the picture holder, thereby increasing the distance between the lens and the image. FIG. 4C shows holder 20B being bent toward the picture holder, thereby decreasing the distance between the lens and the image. Left and right holders 20A and 20B being independently bendable, such maneuvers can achieve adjustment of focus when the flexing is done in unison, and adjustment for diopter differences between a user's eyes when the flexing is done differentially.

FIGS. 5A through 5C are front views that illustrate adjustment of interocular distance by flexion of lens holders 20A and 20B closer together or farther apart in the transverse plane. This maneuver provides adjustment for variations in interpupillary distance among users and also serves to compensate for differences in field separation among the different stereographic formats of content media. Not shown are perpendicular shifts in the transverse plane to adjust vertical alignment.

FIG. 6A through 6D show, in profile, variations in the arrangement of the picture holder flap and the lens holder flap in relation to their respective panels. The preferred arrangement shown in FIG. 6A gives the cleanest appearance to the stereoscope and keeps the pictures and the lenses securely confined. Reversal of the picture holder flap as shown in FIG. 6B makes picture insertion and removal easier, and accommodates larger pictures. Reversal of the lens holder flap as shown in FIGS. 6C and 6D facilitates lens insertion and removal, and is advantageous in a situation where frequent lens exchange or cleaning is desired. It is noted that other patterns of body sheet 11 resulting in other folding geometries of the panels and flaps are possible that accomplish the objectives of the present invention, and are within its scope.

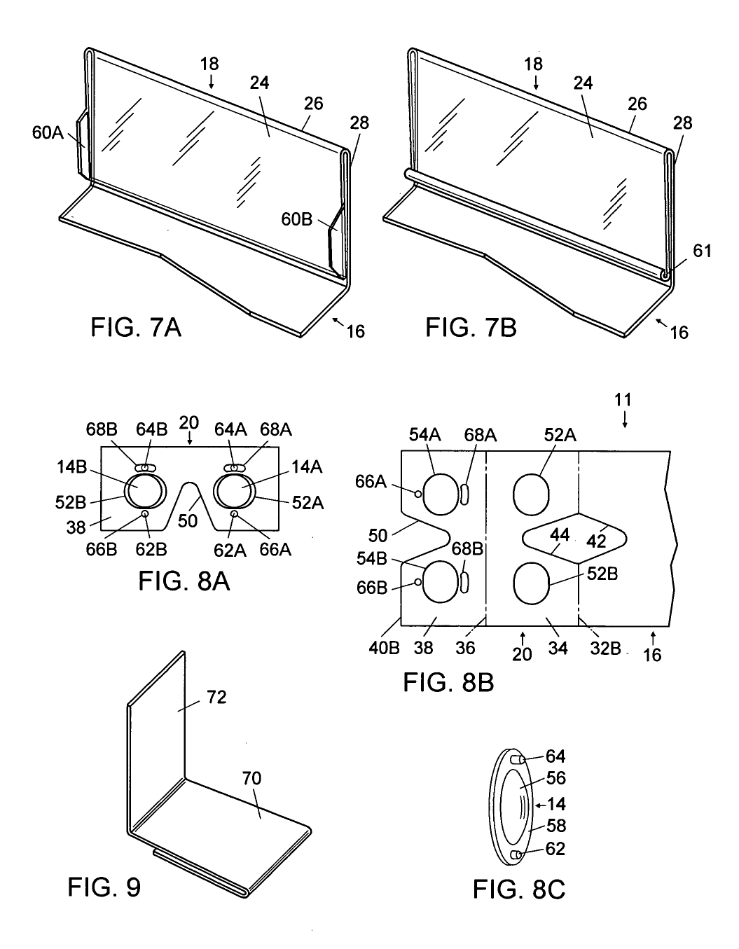

FIG. 7A is a perspective view of picture holder section 18 fitted with optional sidewings 60A and 60B, which serve as retainers for a temporary stereograph placed against the outside of picture holder 18 facing lens holder 20 instead of between panel 28 and flap 24. This allows a user to quickly view a succession of images without inserting each between the picture holder walls. FIG. 7B similarly shows, as a variation, a cylindrical fold at the free edge of flap 24 that forms a retaining channel 61 serving the same purpose. This channel can hold a picture that is larger than the picture holder section.

FIGS. 8A through 8C show in an alternate embodiment, a lens configuration that provides for durably setting the interpupillary distance without flexing the lens holder during each use. FIG. 8A is a front elevation view of lens holder flap 38 with the alternate lenses in place, as seen from picture holder 18. Lenses 14 are fitted with pivot pins 62 and adjustment tabs 64, that mate with pivot holes 66 and tab guides 68 in lens holder flap 38. Lens cutouts 52 and 54 are elongated to provide room for lateral adjustment of lens position made by sliding tabs 64 within guides 68. FIG. 8B shows a detail of the cutout configuration of the body sheet 12 in this case, and FIG. 8C shows a detail of this alternate lens. There is less of a need to bisect panel 34 and flap 38 in this case, and the nose bridge can be left uncut as shown. Slot 42 can also be made shorter, only as extensive as needed to accommodate the user's nose. These modifications give the device greater overall mechanical rigidity and dimensional stability with sacrifice of resilient adjustments other than focus. As a simplifying variation, not pictured, pin 62 and tab 64 along with their matching cutouts can be omitted, and lenses 14 can still be moved within their elongated slots, although the user now has to hold the optical part of a lens to make an adjustment.

The lens and lens aperture configurations depicted in FIGS. 8A through 8C can also be used in the preferred embodiment, in which case the resilient adjustment of interocular distance serves as a fine tuning of the durable adjustment.

Another embodiment of stereoscope 10, not pictured, is formed from a single piece of plastic with the lenses molded in place, obviating the need for a lens holder flap. This unitary construction cleans the style and simplifies the fabrication of the device at the expense of lens interchangeability.

FIG. 9 shows a translucent or opaque septum that clamps onto the base and can serve as a visual “training wheel” for the novice user of the stereoscope. This part is formed from a single rectangular sheet of material folded into base clamp 70 and septum 72.

Operation

The user inserts a stereograph between picture holder panel 28 and flap 24, and views it stereoscopically through lenses 14. The sheet material is flexible and adjustment of the focus may be made by bending lens holder 20 closer to or farther away from picture holder 18. Diopter correction can be made by differentially bending lens holders 20A and 20B. Interocular adjustment can be done by bending these holders in the transverse plane. Adjustment for vertical field alignment is done by flexing holders upward and downward. These maneuvers come naturally and intuitively as the user holds the flexible device in his hands and attempts to see a comfortable 3D image, and even when no correction is finally need, the variation of lens position in a searching manner helps the eyes settle into the proper viewing posture. The optional septum 72 may be installed to help an uninitiated user channel his gaze in the correct direction.

Lenses can easily pop out for cleaning or for replacement with others that suit the vision correction needs of the user. The use of resilient, transparent sheet plastic gives the design a clean and simple appearance, allowing maximum ambient light to fall on the picture while keeping cost to a minimum. The stereoscopic display has a decorative character making it suitable for use as a prominent decoration on a desk, mantle or coffee table.

The stereographic image for use with this device can come either in the form of a pre-aligned and mounted set, or as a loose pair of pictures that are matched in the proper stereoscopic relationship, each image being installed on its respective side of the picture holder. The construction of the picture holder enables the user to insert two separate views on the left and right side, such as taken by two separate cameras disposed in the proper relationship for stereophotography, obviating the need to employ specially constructed stereo cameras or specially prepared stereo views. For still scenes, one camera can be used to generate both views, one taken in a displaced position from the other. For moving subjects, two cameras are used, with simultaneous activation of the shutters from two different positions. The resulting prints are then trimmed to the proper size for sliding into the picture holder.

Another picture, preferably monoscopic, may be inserted facing the other side of the picture holder, so that when the display is placed on a desk, people seated on both sides may enjoy the sight of a picture. For transient viewing of a series of stereographs, these can be rested against the wall of the picture holder facing the lenses, loosely retained by the sidewings or edge channel. If the picture holder flap is fabricated in the form of two halves attached to the lateral sides of the picture holder panel and pressing against its backside, a roll of cartoon stereograms arranged on top of one another can be readily fed through vertically for rapid sequential viewing.

### CONCLUSION, RAMIFICATIONS AND SCOPE

Thus, the reader will see that the present invention provides a simple, versatile, practical, and adjustable stereoscopic display that is inexpensive to manufacture and can be used by people of various ages and with differing interests. While the above description contains many specificities, these should not be construed as limitations on the scope of the invention, but rather as an exemplification of preferred embodiments thereof. Many other variations are possible. For example, the lens holder flaps may fold in from the sides instead of the top, or the lens holder may be connected to the picture holder by sidearms instead of a base. Accordingly, the scope of the invention should be determined not by the embodiments illustrated, but by the appended claims and their legal equivalents.

1. An adjustable stereoscopic display comprising:
a picture holder, a stereoscopic viewer, and a connection means;
the picture holder being configured to position and support stereographic content;
the stereoscopic viewer being configured to position and support a pair of convergent lenses spaced apart by a distance substantially equal to the spacing of human eyes;
the connection means being interposed between said picture holder and said stereoscopic viewer and resiliently connecting said stereoscopic viewer to said picture holder;
the connection means being configured to enable said stereoscopic viewer to be resiliently positioned in alignment with said picture holder and said stereographic content to facilitate perception of said content;

2. The device of claim 1 wherein said picture holder is formed from a sheet of resilient transparent material, comprising a panel and a flap, said flap being joined to said panel along one of its edges by a resilient connection which maintains said panel and said flap spaced from one another at the point of connection and for a portion of their extent, and urges the distal portions into resilient engagement with one another so as to frictionally engage one or more sheets of display material therebetween.

3. The device of claim 1 wherein said stereoscopic viewer comprises a sheet of resilient material formed into a panel, a flap, and a resilient connection that urges them together, said panel and flap being configured with apertures compatible with protruding portions of said lenses to removably hold therebetween said lenses.

4. The device of claim 3 wherein said stereoscopic viewer is provided with adjustment means for adjusting interocular distance.

5. The device of claim 1 wherein said stereoscopic viewer and said connection means are cooperatively configured to support said two lenses separately from one another and to enable resilient motion of said two lenses relative to one another and to said picture holder.

6. The device of claim 1 built entirely from said two lenses and a single sheet of transparent material.

7. The device of claim 1 built entirely from a single piece of transparent material with said lenses integrally molded therein.

8. An adjustable display stereoscope comprising:
two convergent lenses and a body formed from a sheet of resilient transparent material;
each lens comprising a flange having two faces defining two parallel planes and complementarily delimiting protruding parts of the lens;
the sheet having an elongated, substantially rectangular shape defining a longitudinal axis;
the body being formed as three substantially rectangular sections disposed along said longitudinal axis, comprising a first section adapted as a lens holder, a second section adjoining said first section and adapted as a base, and a third section adjoining said second section and adapted as a picture holder;
said lens holder being connected to a first side of said base through a first fold, and said picture holder being connected to a second side of the base opposite said first side through a second fold, in a configuration such that when the base is resting on a horizontal surface, the lens holder and the picture holder are held erect in a substantially vertical position, in a parallel and opposite relationship, and separated by a distance substantially equal to the focal length of the lenses, said longitudinal axis defining a vertical longitudinal plane that bisects said first, second and third sections, said longitudinal plane defining a left side and a right side of the stereoscope as viewed upright from the lens holder toward the picture holder;
said lens holder comprising a first panel connected to the base through said first fold, and a first flap connected to said first panel through a semicylindrical resilient third fold, said first panel and flap collectively defining two walls, a first internal wall closer to said picture holder, and a first external wall farther therefrom, said first walls being separably urged together by said resilient third fold, either or both of said first walls comprising apertures as needed to accommodate said protruding parts and being configured to removably hold therebetween the two lenses, the lenses being symmetrically disposed about said longitudinal plane, spaced apart by the approximate distance between human eyes;
said picture holder comprising a second panel connected to said base through said second fold, and a second flap connected to said second panel through a semicylindrical resilient fourth fold, said second panel and flap collectively defining two walls, a second internal wall closer to the lens holder, and a second external wall farther therefrom, said second walls being separably urged together by said resilient fourth fold, thus being adapted to removably hold therebetween one or more flat image support media bearing a first image facing said lens holder, and optionally a second image facing the opposite direction;
said first image comprising a pair of stereofields physically located on one or more segments of a thin image support media of a reflective or transmissive nature;
a median slot extending along said longitudinal plane from said third fold through said first fold to a location on said base, dividing said lens holder and a portion of the base into two symmetrically disposed lens support arms, the intervening space therebetween being sized and shaped to determine the resilience of said arms under longitudinal and transverse flexion, to provide clearance for their lateral movements, and to accommodate a user's nose;
whereby a stereoscopic image can be assembled, protected and attractively exhibited in a self-standing, two-sided display, and a user looking through the lenses can optimally view it in a fused three-dimensional perception by instantly tuning the optical properties of the stereoscope to fit individual vision requirements and variations in image structure, by resiliently and omnidirectionally shifting the position of the lenses in relation to the image and to one another.

9. An adaptation of the lens holder of the device of claim 8, wherein said apertures in said first walls are elongated such that the lenses can be slid closer together or farther apart, providing for durable setting of interocular distance.

10. A further adaptation of the lens holder of the device of claim 9, wherein each lens is provided with a means of adjustment to enable the slidable setting of interocular distance without the optical part of the lens being grasped.

11. A variation of the lens holder of the device of claim 10, wherein said means of adjustment for each lens is the combination of a pivot and a switch protruding from said flange at diametrically opposite locations, the pivot being received in a pivot hole, and the switch being received in a guide slot in said first internal wall, such that in a neutral state the switch and the pivot are in vertical alignment, and such that the switch can be used to slide the lens towards or away from the other lens, thereby adjusting the lateral spacing between the lenses.

12. An adaptation of the lens holder of the device of claim 8, wherein said first fold comprises more than one curve, rendering it more flexible.

13. An adaptation of the picture holder of the device of claim 8, wherein said second internal wall is provided with at least one sidewing on each lateral edge, each sidewing being folded to aim in the general direction of the ipsilateral lens, at an acute angle to the central portion of said wall such that the field of view from the ipsilateral eye viewpoint is not occluded, and such that an image support medium can be slid in front of said wall and retained by said sidewings, said image support medium not being limited in height.

14. An adaptation of the picture holder of the device of claim 8, wherein the free edge of said second internal wall is provided with a resilient cylindrical fold forming a channel adjacent to said second fold, such that an image support medium can be slid in front of said wall and retained by said channel, such image support medium not being limited in width or height.

15. An adaptation of the device of claim 8, wherein said device is provided with an accessory septum formed from a sheet of resilient, translucent or opaque material, comprising a bottom panel connected to a top panel by a semicylindrical fold which urges them together to form a clamp, and a vertical panel connected to said top panel, in a configuration such that when said clamp slidably engages said base from a side, said vertical panel is positioned in the longitudinal plane adjacent to said picture holder, thereby acting as a light baffle and occluding each stereofield from view by the contralateral eye.

16. An adjustable display stereoscope comprising:
two convergent lenses and a body formed from a sheet of resilient transparent material;
each lens comprising a flange having two faces defining two parallel planes and complementarily delimiting protruding parts of the lens;
the sheet having an elongated, substantially rectangular shape defining a longitudinal axis;
the body being formed as three substantially rectangular sections disposed along said longitudinal axis, comprising a first section adapted as a lens holder, a second section adjoining said first section and adapted as a base, and a third section adjoining said second section and adapted as a picture holder;
the lens holder being connected to a first side of the base through a first fold, and the picture holder being connected to a second side of the base opposite said first side through a second fold, in a configuration such that when the base is resting on a horizontal surface, the lens holder and the picture holder are held erect in a substantially vertical position, in a parallel and opposite relationship, and separated by a distance substantially equal to the focal length of the lenses, said longitudinal axis defining a vertical longitudinal plane that bisects said first, second and third sections, said longitudinal plane defining a left side and a right side of the stereoscope as viewed upright from the lens holder toward the picture holder;
the lens holder comprising a first panel connected to the base through said first fold, and a first flap connected to said first panel through a semicylindrical resilient third fold, said first panel and flap collectively defining two walls, a first internal wall closer to the picture holder, and a first external wall farther therefrom, said first walls being separably urged together by said resilient third fold, either or both of said first walls comprising apertures as needed to accommodate said protruding parts and being configured to removably hold therebetween the two lenses, the lenses being symmetrically disposed about said longitudinal plane, spaced apart by the approximate distance between human eyes;
said apertures in said first walls being elongated such that the lenses can be slid closer together or farther apart, providing for durable setting of interocular distance.
the picture holder comprising a second panel connected to the base through said second fold, and a second flap connected to said second proximal panel through a semicylindrical resilient fourth fold, said second panel and flap collectively defining two walls, a second internal wall closer to the lens holder, and a second external wall farther therefrom, said second walls being separably urged together by said resilient fourth fold, thus being adapted to removably hold therebetween one or more flat image support media bearing a first, stereoscopic, image facing the lens holder, and optionally a second, monoscopic or stereoscopic, image facing the opposite direction;
said first image comprising a pair of symmetrically disposed stereofields physically located on one or more segments of a reflective or transmissive nature, in the form of prints, transparencies, slides, LCDs, or other thin image support media;
a median slot extending along said longitudinal plane from a location near the center of the lens holder through said first fold to a location on the base, said slot being sized and shaped to accommodate a user's nose;
whereby a stereoscopic image can be assembled, protected and attractively exhibited in a self-standing, two-sided display, and a user looking through the lenses can optimally view it in a fused three-dimensional perception by slidably adjusting the interocular distance and resiliently adjusting the focus by flexing the lens holder towards or away from the picture holder.
